(19) United States
(12) Patent Application Publication
(10) Pub. No.: US 2023/0031135 A1
(43) Pub. Date: Feb. 2, 2023

(54) APPARATUS AND METHOD FOR GENERATING HIGHER-LEVEL FEATURES

(71) Applicant: Sony Group Corporation, Tokyo (JP)

(72) Inventors: Francesco CARTELLA, Stuttgart (DE); Francisco FATORE, Stuttgart (DE); Romain HENNETON, Stuttgart (DE)

(73) Assignee: Sony Group Corporation, Tokyo (JP)

(21) Appl. No.: 17/783,653

(22) PCT Filed: Dec. 10, 2020
(86) PCT No.: PCT/EP2020/085643

§ 371 Date: Jun. 9, 2022

(30) Foreign Application Priority Data
Dec. 20, 2019 (EP) 19218882.9

(51) Int. Cl. G06N 5/02

(52) U.S. Cl. CPC G06N 5/022

(57) ABSTRACT

A computer-implemented method for generating higher-level features based on one or more lower-level features of a data set includes generating a higher-level feature using a predefined augmentation of one or more lower-level features, wherein the predefined augmentation comprises a predefined transformation of a lower-level feature and/or a predefined combination of a plurality of lower-level features. The method further includes computing a bivariate similarity metric indicative of a similarity between the generated higher-level feature and the one or more lower-level features. Furthermore, the method comprises adding the higher-level feature to a feature graph, if the metric is less than a predefined threshold. Further, the method comprises outputting a result indicative of the feature graph comprising the lower-level features and the higher-level features.

### FIELD

The present disclosure generally relates to automated feature engineering through feature graph generation and, more particularly, to apparatuses and methods for generating higher-level features based on one or more lower-level features of a data set.

### BACKGROUND

Machine learning, especially its prediction performance, depends on the amount of data being input into a machine learning model and a useful category of the input data. The more data of a useful category are input into the machine learning model, the higher the precision of a prediction may get. A set of raw data being provided for feeding the machine learning model may comprise a plurality of different features being divided into predefined categories. The predefined categories depend on the desired prediction, which requires features of a certain category. Each feature may comprise information corresponding to the feature's category. Due to a high number of features of unnecessary categories in the whole set of raw data, the prediction performance of the machine learning model may suffer as a result. A reason for that may be a plurality of categories, which might not be useful for the machine learning model outputting the prediction. These unnecessary categories may also be involved in the machine learning process of the machine learning model. Thus, said plurality of features of unnecessary categories might increase the required computing performance.

In order to achieve an improved prediction performance, the data being provided for the machine learning model may be reduced in a way to avoid unnecessary effort for the machine learning process. This can be done by use of feature selection.

Feature engineering may be an essential part of a machine learning process. The aim of this process is to generate new predictors or new higher-level or composite features based on the features being part of the set of raw data in order to bring more information of required categories to the machine learning model, thus increase the prediction performance.

The feature engineering process may be a complex and time-consuming manual task that requires expert knowledge and it may be difficult to generate only useful new features. This is an issue for domains where the raw data does not offer much prediction value and new features might be required to create a valuable machine learning model. A solution that can be used is to generate as many features as possible and feed them all in the machine learning model. However, this could degrade the performance of the model due to the extremely high number of features and will increase the computing resources needed to make a prediction.

Hence, there is a need for an improved method for an automated feature engineering.

### SUMMARY

This demand is addressed by the subject-matter of the independent claims. Further useful embodiments are addressed by the dependent claims.

According to a first aspect, the present disclosure provides a computer-implemented method for generating higher-level features based on one or more lower-level features of a data set. The method comprises generating a higher-level feature using a predefined augmentation of one or more lower-level features, wherein the predefined augmentation comprises a predefined transformation of a lower-level feature and/or a predefined combination of a plurality of lower-level features. The method further comprises computing a bivariate similarity metric indicative of a similarity between the generated higher-level feature and the one or more lower-level features. Further, the method comprises adding the higher-level feature to a feature graph, if the metric is less than a predefined threshold. Furthermore, the method comprises outputting a result indicative of the feature graph comprising the lower-level features and the higher-level features.

According to a second aspect, the present disclosure provides an apparatus for generating higher-level features is based on one or more lower-level features of a data set. The apparatus comprises a circuitry which is configured to generate a higher-level feature using a predefined augmentation of one or more lower-level features. The predefined augmentation comprises a predefined transformation of a lower-level feature and/or a predefined combination of a plurality of lower-level features. The apparatus is further configured to compute a bivariate similarity metric indicative of a similarity between the generated higher-level feature and the one or more lower-level features. Furthermore, the apparatus is configured to add the higher-level feature to a feature graph, if the metric is less than a predefined threshold. The apparatus is further configured to output a result indicative of the feature graph comprising the lower-level features and the higher-level features.

### BRIEF DESCRIPTION OF THE FIGURES

Some examples of apparatuses and/or methods will be described in the following by way of example only, and with reference to the accompanying figures, in which

FIG. 1 illustrates a flowchart of an example of a method for generating higher-level features;

FIG. 2 schematically illustrates an example of a feature graph; and

FIG. 3 illustrates a block diagram of an exemplary apparatus for generating higher-level features.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Same or like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled via one or more intervening elements. If two elements A and B are combined using an “or”, this is to be understood to disclose all possible combinations, i.e. only A, only B as well as A and B, if not explicitly or implicitly defined otherwise. An alternative wording for the same combinations is “at least one of A and B” or “A and/or B”. The same applies, mutatis mutandis, for combinations of more than two Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

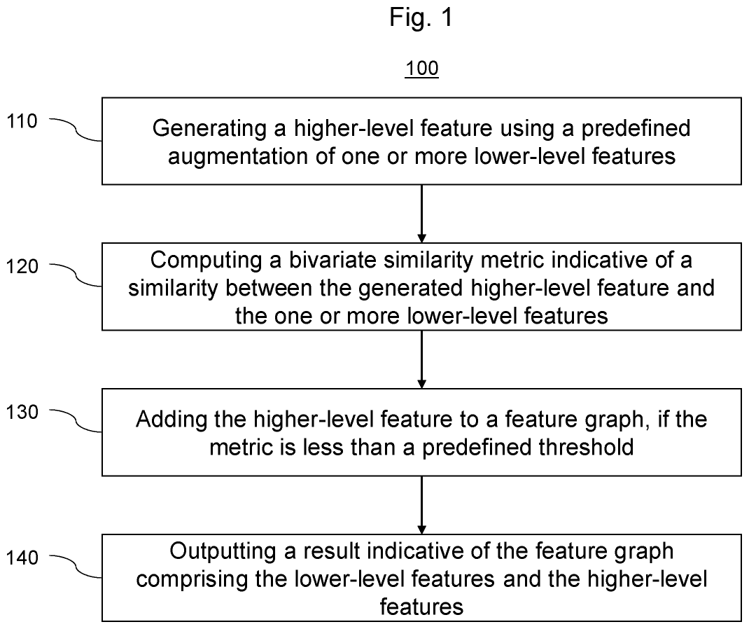

FIG. 1 illustrates a computer-implemented method 100 for generating higher-level features based on one or more lower-level features of a data set. Method 100 is performed by an apparatus for generating higher-level features. The apparatus comprises a circuitry performing an algorithm for executing a feature engineering model. Said algorithm may be an example for the computer-implemented method. The steps of said method may be performed as follows.

The method 100 comprises generating 110 a higher-level feature using a predefined augmentation of one or more lower-level features. The predefined augmentation may comprise a predefined transformation of a lower-level feature and/or a predefined combination of a plurality of lower-level features.

A higher-level feature may belong to a higher layer of a feature graph, whereas a lower-level feature may belong to a lower layer of the feature graph. A higher-level feature may be based on one or more lower-level features, i.e., it may be a derivate or a composition of one or more lower-level features. Said derivates or compositions may also be or based on augmentations. A newly generated higher-level feature may be added to the feature graph if it adds useful information with respect to the lower- and higher-level features already existing in the feature graph. For this purpose, the method 100 further comprises computing 120 a bivariate similarity metric indicative of a similarity between the generated higher-level feature and the one or more lower-level features. Computing 120 the bivariate similarity metric may comprise computing a correlation and/or mutual information between the generated higher-level feature and the one or more lower-level features. In particular, computing 120 may comprise computing bivariate similarity metrics between the generated higher-level feature and all other lower- or higher-level feature of the feature graph. This may help to determine whether and to which extent the information of two or more higher- and lower-level features are similar.

The mutual information of two random variables, i.e. the higher-level and lower-level features, may be a measure of the mutual dependence between the two variables. More specifically, it may quantify the amount of information obtained about one random variable through observing the other random variable. The concept of mutual information may be intricately linked to that of entropy of a random variable, a fundamental notion in information theory that quantifies an expected amount of information held in a random variable.

Regarding the correlation in statistics, dependence or association may be any statistical relationship, whether causal or not, between two random variables or bivariate data. In the broadest sense, correlation may be any statistical association, though it may commonly refer to the degree to which a pair of variables may be linearly related.

Further, the method 100 comprises adding 130 the higher-level feature to a feature graph, if the metric is less than a predefined threshold. In particular, the generated higher-level feature may be added to the feature graph, if all of the bivariate similarity metrics between the generated higher-level feature and all other lower- or higher-level feature are less than the predefined threshold.

In other words, all (higher-level) features comprising new information may be illustrated as nodes in a feature graph. The higher-level features may be illustrated as combinations of two or more lower-level features. In case a newly generated higher-level feature may comprise new information compared to the lower-level features, the higher-level feature may be added to the feature graph. Here, the amount of new information of a new higher-level feature may be higher than a predefined threshold. If the amount of new information is below said threshold, the newly generated higher-level feature may not be added to the feature graph. In this way, redundant information in a feature graph may be avoided or at least reduced.

In an optional example, each of the lower-level features may belong to one of a plurality of predefined feature categories. Each of the predefined feature categories may have a predefined importance level associated therewith. The predefined augmentation for generating the higher-level feature may be based on a feature category and the associated importance level of the one or more lower-level features.

In other words, the predefined feature categories and their importance level of each may correspond to the categories being relevant/required for the prediction to be processed by the machine learning model. The importance level may further improve the optimal feature selection to feed the machine learning model for an improved prediction performance.

In a further example, a predefined transformation may be defined by a mathematical operator and the predefined combination may be defined by a mathematical function dependent on at least two variables, wherein the variables are lower-level features.

An example of the method 100 comprises a plurality of iterations. During a first iteration, generating a first higher-level feature may comprise using a first predefined augmentation of the one or more lower-level features. During a second iteration, generating a second higher-level feature may comprise using a second predefined augmentation of the one or more lower-level features.

The iterations may be repeated until for all possible predefined augmentations no higher-level features having similarity metrics less than the predefined threshold may be found or until a maximum number of iterations may reached.

Optionally, the number of iterations may be set to a predefined maximum number. This may lead to a limited number of features. This may further improve the prediction performance.

Reaching the maximum number of newly generated features, each comprising new information, and the feature graph may comprise a maximum possible information for feeding the machine learning model in order to improve the prediction performance of the machine learning process.

In an additional example, the feature graph may be populated with lower- and higher-level features in accordance with a breadth first search. In other words, the feature engineering process may be performed layer by layer, which means that first all possible new higher-level features may be generated for one layer based on the lower-level features in the previous layers. Once this may be done, the feature engineering process may move on to the next layer depth.

In an optional example, the result indicative of the feature graph is used as input data for a machine learning algorithm.

Furthermore, the method 100 comprises outputting 140 a result indicative of the feature graph comprising the lower-level features and the higher-level features. These features may then be used to train a machine learning model. Due to the features selected by the feature engineering process the most useful features are used, leading to an improved prediction performance compared to a machine leaning process with all potential features.

Automated feature engineering using the method 100 may be more efficient and repeatable than manual feature engineering allowing to build better predictive models in a faster way.

After the automated feature engineering process, the most useful features of the required categories corresponding to the desired prediction of a certain metric may be input to the machine learning model in order to improve the machine learning process for outputting said prediction.

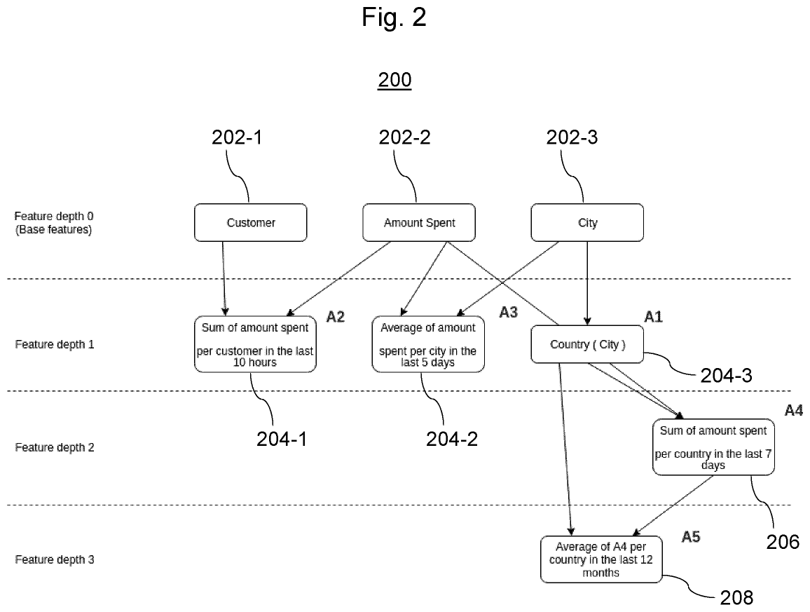

In order to illustrate the proposed automated feature engineering process 100, FIG. 2 illustrates an example of a feature graph 200. Such a feature graph is a layered acyclic graph, where the features are represented by nodes. The base features being provided by a given raw data set are located in the feature layer of depth 0, which is the lowest depth of a feature layer.

These base features each belong to a category or different categories. Categories may be, for example, “financial issues”, “locations”, “individuals” or “time related issues”. In this example, the raw data set is a transactional data set. One of the possible categories may be “financial issues”. Further, the base features in layer depth 0 are “customer” 202-1, “amount spent” 202-2 and “city” 202-3. The feature “customer” 202-1 belongs to the category “individuals”, the feature “amount spent” 202-2 belongs to the category “financial issues”, and the feature “city” 202-3 belongs to the category “locations”.

New features can be generated by applying an augmentation on a subset of features. Augmentations may be generated by extracting, for example, the “country” from the “city” name. This augmented feature is called “country” 204-3. Now, the set of features of the feature graph 200 has one more feature with “country” 204-3. Based on this set of features, new augmentations can be computed, like “sum of amount spent per customer in the last 10 hours” 204-1, “average of amount spent per city in the last 5 days” 204-2, and “sum of amount spent per country in the last 7 days” 206. With these new features, the set of features of the feature graph 200 has three more features. The features “sum of amount spent per customer in the last 10 hours” 204-1, “average of amount spent per city in the last 5 days” 204-2, and “country” 204-3 are located in feature depth layer 1, which is the first of the higher feature depth layers. The features in this layer are called higher-level features compared to the base feature in feature depth layer 0. The base features are called lower-level features compared to the features in feature depth layer 1 (and above). The feature “sum of amount spent per country in the last 7 days” 206 is generated out of a combination of the base feature “amount spent” 202-2 and “country” 204-3. This example shows that new features may also be generated as combinations of features located in different feature depth layers. Such features may become more complex. Said feature 206 is located in feature depth layer 2, which means that it is a higher-level feature compared to the features in feature depth layers 0 and 1, whereas the features in feature depth layers 0 and 1 are lower-level features compared to the features in feature depth layer 2 (and above). The set of features of the feature graph 200 has now one more feature with feature 206. As an example, an average of feature 206 can be computed as a new augmentation “average of (sum of amount spent per country over last 7 days) per country in the last 12 months” 208. This translates to “on average, and based on the last year data, what is the total amount of money spent by a country over a week”. This feature is located in feature layer depth 3. Compared to the features in the feature depth layers 0 to 2 it is a higher-level feature, whereas feature 206 in feature depth layer 2 is a lower-level feature compared to feature 208 in feature depth layer 3.

In short, features in a feature layer of a lower depth are called lower-level features compared to features in a feature layer of a higher depth, whereas the features in a feature layer of a higher depth are called higher-level features compared to features in a feature layer of a lower depth. It is to be noted that higher-level feature and lower-level feature are relative designations referring to the feature layer depths directly next or previous feature layer depth.

The example feature graph 200 is based on an example of a transactional data set, where new data points are provided with a time stamp. This enables creating a plurality of different statistics like, for example, amount of money spent over a period of time, the time period between two sequential payments or a daily average of payments over one year. Thus, lots of new augmentations may be created. As an assumption, there may be two types of augmentations in a transactional data set. There may be transformations and agglomerations. Transformations may be augmentations that may be computed based on the current data point only, i.e. logarithm of the amount spent in the current transaction. Agglomerations may be augmentations that need historical data points to be computed, e.g. sum of money spent via credit card over the last ten days, or time between the current transaction and the last transaction.

Further, augmentations may be combined with other augmentations in order to create more new features which may be more complex. All these features may be plotted in corresponding feature depth layers of the feature graph 200 as illustrated in FIG. 2.

With the number of potential augmentations being huge, and the feature layer depth potentially infinity, the number of potential features may be infinite as well. Multiple issues may arise if too many features are present in the feature graph 200. For example, the efficiency of the machine learning model may suffer from the presence of too many features, and with this the required computational power may increase. This may lead to more time to be spent and higher costs.

To summarize the process of feature engineering as illustrated in FIG. 2, the feature graph 200 with feature layer depth 0 may be created comprising the base features being provided by the raw data set. The set of augmentations may be predefined. The features may be created based on augmentations layer by layer in a Breadth First Search way. In order to reduce the search space on next layers, only features that bring new information may be added. Features that do not bring additional information are excluded. Informative features, means features that are different enough compared to the features already present in the data set. In order to perform that pruning, a bivariate metric like mutual information may be used, comparing the similarity between two features. If two features have a high mutual information, keeping both of them may not bring more information than keeping only one of them. Therefore the second feature may be dropped without harming the performance of the final classification/regression task.

After creating new features in each feature depth layer of the feature graph 200, each new feature may be verified being not similar enough to all the other features already present in the graph. As already explained, if the feature may not be too similar to any of the features already present, it may be added to the set of features of the feature graph 200. Otherwise, it may be dropped in order to avoid redundant information.

The automated feature engineering process may be a method that may allow to generate new features automatically. It may also determine which reduced set of augmentations may be computed on new observations. This reduced set of augmentations may contain the augmentations that provide as much additional information as possible, without adding redundant information. Then, the model may make a prediction based on the additional available information.

The main advantage may be that complex features bringing useful information may be computed whilst keeping the number of features computed at a minimum. This process may be fully automated and may be tuned depending on the available computing capabilities that the user may be willing to use and the performance that he may want to reach.

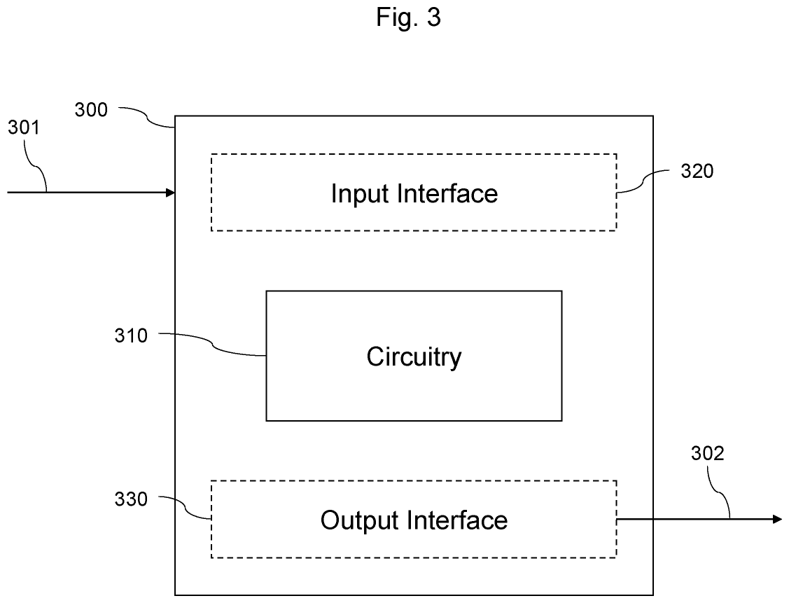

FIG. 3 illustrates an example of an apparatus 300 for generating higher-level features based on one or more lower-level features of a data set. The apparatus 300 comprises a circuitry 310 for performing an algorithm for executing a feature engineering model. For inputting a raw data set 301, the apparatus 300 may additionally comprise an input interface 320. In order to output a result 302 from the circuitry 310, the apparatus 300 may optionally comprise an output interface 330. The circuitry 310 is configured to generate a higher-level feature using a predefined augmentation of one or more lower-level features.

The predefined augmentation may comprise a predefined transformation of a lower-level feature and/or a predefined combination of a plurality of lower-level features.

The apparatus 300 may further be configured to compute a bivariate similarity metric indicative of a similarity between the generated higher-level feature and the one or more lower-level features. Furthermore, the apparatus may be configured to add the higher-level feature to a feature graph, if the metric might be less than a predefined threshold. The apparatus may further be configured to output a result indicative of the feature graph comprising the lower-level features and the higher-level features.

In an example, the circuitry 310 may further be configured to compute a correlation and/or mutual information between the generated higher-level feature and the one or more lower-level features. In particular the circuitry 310 may be configured to compute bivariate similarity metrics between the generated higher-level feature and all other lower- or higher-level feature of the feature graph.

For example, the circuitry 310 is further configured to add the generated higher-level feature to the feature graph, if all of the bivariate similarity metrics between the generated higher-level feature and all other lower- or higher-level feature may be less than the predefined threshold.

Optionally, the circuitry 310 is further configured to perform a plurality of iterations. During a first iteration, generating a first higher-level feature may comprise using a first predefined augmentation of the one or more lower-level features. During a second iteration generating, a second higher-level feature may comprise using a second predefined augmentation of the one or more lower-level features.

In another example, the circuitry 310 may further be configured to repeat the iterations until for all possible predefined augmentations no higher-level features having similarity metrics less than the predefined threshold may be found or until a maximum number of iterations is reached.

However, the proposed apparatus for generating higher-level features is not limited to the specific examples.

Automated feature engineering may improve by automatically extracting useful and meaningful features from a set of raw data with a framework that may be applied to any problem. It may not only cut down on the time spent feature engineering, but may create interpretable features and may prevent data leakage by filtering time-dependent data. In short, automated feature engineering may be more efficient and repeatable than manual feature engineering allowing to build better predictive models in a faster way.

The proposed automated feature engineering process may aim to obtain a more meaningful and useful set of features in an unsupervised way, in order to improve the creation of a machine learning model on top of those features. This will allow to create more efficient models in a faster way, without the need of manually defining all the potentially useful augmentations. This may improve supervised and unsupervised machine learning methods.

Further, the proposed automated feature engineering process may be distributed and scaled horizontally in an efficient way. The computation of each feature on a layer may be independent and may be distributed. Also, the computation of the similarity measure may be computed independently for each pair of features, which may allow this operation to be scaled horizontally as well.

The proposed automated feature engineering methodology may be offered as a service for third parties' analysis and applications. As such, a detailed description of the feature engineering performed may also be provided to the users. Systems running the proposed methodology may output some kind of definition of the reduced generated feature graph, in order to allow the user of the service to compute the same features on future observations. For example, in the classic use case of machine learning, if a model was built on top of the generated features, the user may need to have a way of knowing which features he may generate and how to generate them. Therefore, a summary of the final feature graph may be provided to the user, or alternatively, a package allowing to compute those useful features on new observations.

The model of the automated feature engineering may be included in digital systems designed for software service that offer modeling and data analysis capabilities. These systems may include data centers or computer servers running on cloud infrastructures. The output of the system may then lead to another package that may allow to generate those features at will. Depending on the nature of the feature generated, those may be generated directly where observations may be made, which may prevent the need for a central system (potentially on the cloud) computing the features and making the prediction. As an example, the produced feature generation package may be directly deployed in devices like TV's, phones, laptops in order to compute locally (on the device) the features. If the machine learning model may be deployed on the device as well, the full machine learning solution with feature engineering and target prediction may be deployed on the device, removing the need of making calls to a web-service.

As an additional example for the automated feature engineering model, an algorithm may be used as described in the following.

Inputs for said algorithm may be a transactional data set, a bivariate metric, a threshold, augmentations, the feature's category and a maximum depth of a feature graph.

The input data set, may be represented in this case as a set of features in an M*N matrix of M rows (M data points) and N columns (N features).

The bivariate metric may measure the similarity between two features and may be correlation or mutual information. The result of measuring the similarity of two features may be a value between 0 and 1, where the value 0 may stand for independent features and the value 1 for equal features.

Therefore, the threshold may be a value between 0 and 1 marking the minimum metric value that may indicate the redundancy of information between two features.

A set of augmentations that may be performed on features.

The information about the input data may be, for example, the feature category for each feature.

An optional field in the algorithm marking the maximum depth (complexity) of the feature graph, may equal to infinity if it may not specified.

The output of the algorithm may be a result comprising the base features and the new features generated, for example an M*(N+Np) matrix where Np is equal to the number of newly generated features.

The function for generating new features is shown in the following part of the algorithm:

```
  Function generateFeatures(Metric, Data, Augmentations, FInformation, MaxDepth):
  Result = Data.copy( )
  currentLayer = 1
  while currentLayer <= MaxDepth:
  addedFeatures = 0
  // Generate all the potential features for the new layer of the graph
  potentialFeatures = generatePotentialNewFeatures(Result, Augmentations, FInfor-
  mation)
  // Keep only the features that bring new information;
  //Remove features which bring redundant information when compared to the Result
  features.
  for feature in potentialFeatures:
  maximumRedundancyMeasure = 0
  for existingFeature in result:
  maximumRedundancyMeasure = max(maximumRedundancyMeasure,
  Metric(existinfeature, feature))
  // If the feature is not redundant with any of the already present feature,
  //it means that it brings new information and can be added to the Result.
  if maximumRedencancyMeasure < Threshold:
  Result.append(feature)
  addedFeatures = addedFeatures + 1
  // If no feature which is not redundant can be added on this layer,
  //stop the algorithm and return the computed set of features.
  if addedFeatures == 0 :
  Stop the loop, no new feature that brings non-redundant information can be created
  currentLayer = currentLayer + 1
  return Result
  Function generatePotentialNewFeatures(ExistingFeatures, Augmentations, FInfor-
  mation):
  //Take all the existing features and based on the FInformation,
  //see what augmentations can be performed.
  //An augmentation can be performed if we can find a subset of features that meets
  //the augmentation requirements in terms of input feature types (and potentially im-
  portance).
  //This function returns then the set of all the features that can be generated through
  those
//augmentations based on the Existing Features (Base features + newly generated features).
```

Further to the exemplary logarithm, an example of executing the algorithm is given based on a transactional data set, comprising the base features “Customer”, “Amount” and “Currency”, as shown in the following table.

| Customer | Amount | Currency |
|---|---|---|
| A | 10 | EUR |
| A | 2 | EUR |
| B | 20 | EUR |
| B | 4 | EUR |
| C | 30 | USD |
| D | 15 | EUR |
| D | 6 | USD |
| E | 20 | EUR |

The feature “Customer” may belong to the category “individual”, “Amount” may belong to the category “financial issues” and “Currency” may belong to the category “currency”.

Possible augmentations may be “MultiCurrencyToUSD”, “MultiCurrencyToEUR”, and “TotalPerCategory”. The augmentation “MultiCurrencyToUSD” may transform a currency to USD. “MultiCurrencyToEUR” may transform a currency to EUR. “TotalPerCategory” may compute the total of a numerical for a category.

In this example, the metric may be chosen as correlation, the threshold value may be chosen as 0.9 and the maximum depth (MxDepth) value may be 2.

Due to the maximum depth of 2, the algorithm may execute 2 iterations. At each iteration, a list of potential features and their value may be shown, in this example the amount as USD and the amount as EUR, as shown in the following table after the first iteration of executing the algorithm.

| | | | Amount | Amount |
|---|---|---|---|---|
| Customer | Amount | Currency | as USD | as EUR |
| A | 10 | EUR | 20 | 10 |
| A | 2 | EUR | 4 | 2 |
| B | 20 | EUR | 40 | 20 |
| B | 4 | EUR | 8 | 4 |
| C | 30 | USD | 30 | 15 |
| D | 15 | EUR | 30 | 15 |
| D | 6 | USD | 6 | 3 |
| E | 20 | EUR | 40 | 20 |

The correlation between the “amount” and the “amount as USD” may be 0.84 being below the threshold 0.9. The “amount as USD” may then be added to the feature graph.

The correlation the “amount” and the “amount as EUR” may be 1.0 which is above the threshold value 0.9. Thus, the “amount as EUR” may not be added to the feature graph.

The next table shows the potential features of the second iteration of executing the algorithm.

| | | | amount | total USD |
|---|---|---|---|---|
| Customer | Amount | Currency | as USD | per customer |
| A | 10 | EUR | 20 | 24 |
| A | 2 | EUR | 4 | 24 |
| B | 20 | EUR | 40 | 48 |
| B | 4 | EUR | 8 | 48 |
| C | 30 | USD | 30 | 30 |
| D | 15 | EUR | 30 | 36 |
| D | 6 | USD | 6 | 36 |
| E | 20 | EUR | 40 | 40 |

The correlation between the “amount” and the newly generated “total amount as USD per customer” may be 0.11. The correlation between the “amount as USD” and “total amount as USD per customer” may be 0.31. Both correlation values may be below the threshold value 0.9. Therefore, the newly generated feature “total amount as USD per customer” may be added.

In the following table, the final result of executing the algorithm with two iterations is shown.

| | | | Amount | Total USD |
|---|---|---|---|---|
| Customer | Amount | Currency | as USD | per customer |
| A | 10 | EUR | 20 | 24 |
| A | 2 | EUR | 4 | 24 |
| B | 20 | EUR | 40 | 48 |
| B | 4 | EUR | 8 | 48 |
| C | 30 | USD | 30 | 30 |
| D | 15 | EUR | 30 | 36 |
| D | 6 | USD | 6 | 36 |
| E | 20 | EUR | 40 | 40 |

In case, the redundant information may not be removed early enough, the feature “total EUR per customer” may be generated in the second iteration. This feature may be redundant to the feature “total USD per customer” as well as the “amount as EUR”, which is redundant with “amount as USD”. In the table below, these features are shown.

| | | | | | Total | Total |
|---|---|---|---|---|---|---|
| | | Cur- | Amount | Amount | USD per | EUR per |
| Customer | Amount | rency | as USD | as EUR | customer | customer |
| A | 10 | EUR | 20 | 10 | 24 | 12 |
| A | 2 | EUR | 4 | 2 | 24 | 12 |
| B | 20 | EUR | 40 | 20 | 48 | 24 |
| B | 4 | EUR | 8 | 4 | 48 | 24 |
| C | 30 | USD | 30 | 15 | 30 | 15 |
| D | 15 | EUR | 30 | 15 | 36 | 18 |
| D | 6 | USD | 6 | 3 | 36 | 18 |
| E | 20 | EUR | 40 | 20 | 40 | 20 |

Note that the present technology can also be configured as described below.

(1) A computer-implemented method for generating higher-level features based on one or more lower-level features of a data set, the method comprising

generating a higher-level feature using a predefined augmentation of one or more lower-level features, wherein the predefined augmentation comprises a predefined transformation of a lower-level feature and/or a predefined combination of a plurality of lower-level features; computing a bivariate similarity metric indicative of a similarity between the generated higher-level feature and the one or more lower-level features;

adding the higher-level feature to a feature graph, if the metric is less than a predefined threshold; and

outputting a result indicative of the feature graph comprising the lower-level features and the higher-level features.

(2) The method according to (1), wherein computing the bivariate similarity metric comprises computing a correlation and/or mutual information between the generated higher-level feature and the one or more lower-level features.

(3) The method according to any one of (1) or (2), comprising computing bivariate similarity metrics between the generated higher-level feature and all other lower- or higher-level feature of the feature graph.

(4) The method according to (3), wherein the generated higher-level feature is added to the feature graph, if all of the bivariate similarity metrics between the generated higher-level feature and all other lower- or higher-level feature are less than the predefined threshold.

(5) The method according to any one of (1) to (4), wherein each of the lower-level features belongs to one of a plurality of predefined feature categories, wherein each of the predefined feature categories has a predefined importance level associated therewith, wherein the predefined augmentation for generating the higher-level feature is based on a feature category and the associated importance level of the one or more lower-level features.

(6) The method according to any one of (1) to (5), wherein the predefined transformation is defined by a mathematical operator and the predefined combination is defined by a mathematical function dependent on at least two variables, wherein the variables are lower-level features.

(7) The method according to any one of (1) to (6), wherein the method comprises a plurality of iterations, wherein during a first iteration generating a first higher-level feature comprises using a first predefined augmentation of the one or more lower-level features and during a second iteration generating a second higher-level feature comprises using a second predefined augmentation of the one or more lower-level features.

(8) The method according to (7), wherein the iterations are repeated until for all possible predefined augmentations no higher-level features having similarity metrics less than the predefined threshold can be found or until a maximum number of iterations is reached.

(9) The method according to any one of (1) to (8), wherein the feature graph is populated with lower- and higher-level features in accordance with a breadth first search.

(10) The method according to any one of (1) to (9), wherein the result indicative of the feature graph is used as input data for a machine learning algorithm.

(11) An apparatus for generating higher-level features based on one or more lower-level features of a data set, the apparatus comprising a circuitry configured to

generate a higher-level feature using a predefined augmentation of one or more lower-level features, wherein the predefined augmentation comprises a predefined transformation of a lower-level feature and/or a predefined combination of a plurality of lower-level features; compute a bivariate similarity metric indicative of a similarity between the generated higher-level feature and the one or more lower-level features;

add the higher-level feature to a feature graph, if the metric is less than a predefined threshold; and

output a result indicative of the feature graph comprising the lower-level features and the higher-level features.

(12) The apparatus according to (11), wherein the circuitry is further configured to compute a correlation and/or mutual information between the generated higher-level feature and the one or more lower-level features.

(13) The apparatus according to (11) or (12), wherein the circuitry is further configured to compute bivariate similarity metrics between the generated higher-level feature and all other lower- or higher-level feature of the feature graph.

(14) The apparatus according to any one of (11) to (13), wherein the circuitry is further configured to add the generated higher-level feature to the feature graph, if all of the bivariate similarity metrics between the generated higher-level feature and all other lower- or higher-level feature are less than the predefined threshold.

(15) The apparatus according to any one of (11) to (14), wherein the circuitry is further configured to perform a plurality of iterations, wherein during a first iteration generating a first higher-level feature comprises using a first predefined augmentation of the one or more lower-level features and during a second iteration generating a second higher-level feature comprises using a second predefined augmentation of the one or more lower-level features.

(16) The apparatus according to any one of (11) to (15), wherein the circuitry is further configured to repeat the iterations until for all possible predefined augmentations no higher-level features having similarity metrics less than the predefined threshold can be found or until a maximum number of iterations is reached.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for illustrative purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a signal”, “means for generating a signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software, but may include digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A computer-implemented method for generating higher-level features based on one or more lower-level features of a data set, the method comprising
generating a higher-level feature using a predefined augmentation of one or more lower-level features, wherein the predefined augmentation comprises a predefined transformation of a lower-level feature and/or a predefined combination of a plurality of lower-level features;
computing a bivariate similarity metric indicative of a similarity between the generated higher-level feature and the one or more lower-level features;
adding the higher-level feature to a feature graph, if the metric is less than a predefined threshold; and
outputting a result indicative of the feature graph comprising the lower-level features and the higher-level features.

2. The method of claim 1, wherein computing the bivariate similarity metric comprises computing a correlation and/or mutual information between the generated higher-level feature and the one or more lower-level features.

3. The method of claim 1, comprising computing bivariate similarity metrics between the generated higher-level feature and all other lower- or higher-level feature of the feature graph.

4. The method of claim 3, wherein the generated higher-level feature is added to the feature graph, if all of the bivariate similarity metrics between the generated higher-level feature and all other lower- or higher-level feature are less than the predefined threshold.

5. The method of claim 1, wherein each of the lower-level features belongs to one of a plurality of predefined feature categories, wherein each of the predefined feature categories has a predefined importance level associated therewith, wherein the predefined augmentation for generating the higher-level feature is based on a feature category and the associated importance level of the one or more lower-level features.

6. The method of claim 1, wherein the predefined transformation is defined by a mathematical operator and the predefined combination is defined by a mathematical function dependent on at least two variables, wherein the variables are lower-level features.

7. The method of claim 1, wherein the method comprises a plurality of iterations, wherein during a first iteration generating a first higher-level feature comprises using a first predefined augmentation of the one or more lower-level features and during a second iteration generating a second higher-level feature comprises using a second predefined augmentation of the one or more lower-level features.

8. The method of claim 7, wherein the iterations are repeated until for all possible predefined augmentations no higher-level features having similarity metrics less than the predefined threshold can be found or until a maximum number of iterations is reached.

9. The method of claim 1, wherein the feature graph is populated with lower- and higher-level features in accordance with a breadth first search.

10. The method of claim 1, wherein the result indicative of the feature graph is used as input data for a machine learning algorithm.

11. An apparatus for generating higher-level features based on one or more lower-level features of a data set, the apparatus comprising circuitry configured to
generate a higher-level feature using a predefined augmentation of one or more lower-level features, wherein the predefined augmentation comprises a predefined transformation of a lower-level feature and/or a predefined combination of a plurality of lower-level features;
compute a bivariate similarity metric indicative of a similarity between the generated higher-level feature and the one or more lower-level features;
add the higher-level feature to a feature graph, if the metric is less than a predefined threshold; and
output a result indicative of the feature graph comprising the lower-level features and the higher-level features.

12. The apparatus of claim 11, wherein the circuitry is further configured to compute a correlation and/or mutual information between the generated higher-level feature and the one or more lower-level features.

13. The apparatus of claim 11, wherein the circuitry is further configured to compute bivariate similarity metrics between the generated higher-level feature and all other lower- or higher-level feature of the feature graph.

14. The apparatus of claim 11, wherein the circuitry is further configured to add the generated higher-level feature to the feature graph, if all of the bivariate similarity metrics between the generated higher-level feature and all other lower- or higher-level feature are less than the predefined threshold.

15. The apparatus of claim 11, wherein the circuitry is further configured to perform a plurality of iterations, wherein during a first iteration generating a first higher-level feature comprises using a first predefined augmentation of the one or more lower-level features and during a second iteration generating a second higher-level feature comprises using a second predefined augmentation of the one or more lower-level features.

16. The apparatus of claim 11, wherein the circuitry is further configured to repeat the iterations until for all possible predefined augmentations no higher-level features having similarity metrics less than the predefined threshold can be found or until a maximum number of iterations is reached.
